(19) United States
(12) Patent Application Publication
(10) Pub. No.: US 2004/0151008 A1
(43) Pub. Date: Aug. 5, 2004

(54) Variable spot size illuminators with enhanced homogeneity and parfocality

(76) Inventors: Alexander N. Artsyukhovich, Aliso Viejo, CA (US); Burno X. Lassalas, Irvine, CA (US); T. Scott Rowe, Dana Point, CA (US); Robert E. Fischer, Westlake Village, CA (US)

Correspondence Address: ALCON RESEARCH, LTD., R&D COUNSEL, Q-148, 6201 SOUTH FREEWAY, FORT WORTH, TX, 76134-2099, US

(21) Appl. No.: 10/357,006

(22) Filed: Feb. 3, 2003

(51) Int. Cl. G02B 6/00

(52) U.S. Cl. 362/572; 362/551; 362/268; 362/558

(57) ABSTRACT

The present invention provides both continuously variable spot size illuminators and discretely variable spot size illuminators that can be utilized in many applications, e.g., photo-dynamic therapy, to provide a light spot on a treatment plane, e.g., a patient's retina, whose size can be continuously or discretely adjusted while ensuring that the light fluence and the working focal distance remain substantially constant at all spot sizes, thereby preserving parfocality with other optical systems. In a continuous variable spot size illuminator of the invention, a focusing lens system is employed to form an image of a light source on an intermediate plane, and a variable aperture is utilized to select a portion of the intermediate image. An objective lens system then images the selected portion of the intermediate image onto a treatment plane. A discrete variable spot size illuminator of the invention employs a plurality of light shaping diffusers each imparting a pre-defined far field intensity distribution to light transmitted therethrough to select the shape and/or size of an image formed on a treatment plane from among a discrete number of choices, each associated with coupling one of the diffuser with a light source.

### BACKGROUND OF THE INVENTION

The present invention relates generally to variable spot size medical illuminators, and more particularly, to such illuminators that allow continuously or discretely adjusting the size of an illumination spot on a treatment plane while ensuring that the illumination fluence remains substantially constant.

A number of ophthalmic surgical procedures performed on a patient's retina require illuminating a selected portion of the retina with a light spot, typically provided by a laser, having a desired size. In one such procedure, commonly known as “photodynamic therapy,” an agent, which is harmless in the absence of light activation, is initially administered intravenously to the patient. Subsequently, abnormally highly vascularized retinal tissue containing the agent is illuminated with laser light having a selected wavelength to activate the agent. The activated agent can destroy the abnormal tissue or have other therapeutic effect.

In another ophthalmic surgical procedure, typically referred to as retinal photocoagulation, a laser light spot is directed to a selected portion of a patient's retina to deposit energy, thereby causing coagulation of the local tissue. Such a photocoagulation procedure can be employed, for example, to seal leaky blood vessels, destroy abnormal blood vessels, or seal retinal tears.

In such procedures, it is generally advantageous that the intensity profile of the light spot be substantially uniform, and remain stable over the illumination time period. Further, a surgeon performing such a procedure may need to change the spot size while ensuring that the illumination fluence remains constant. In practice, a surgeon typically employs an illuminator for performing an ophthalmic procedure together with an observation system, such as a slit lamp microscope or an indirect ophthalmoscope, that allows the surgeon to observe the area to be treated. The focus associated with the illuminator should coincide with the focus associated with the observation system so that the surgeon can simultaneously observe and treat a desired area. That is, it is desirable that the illuminator and the observation system be parfocal. In general, two independent optical systems with foci that lie on the same focal plane are known as being parfocal, and this relationship is known as parfocality. Traditional variable spot size illuminators provide variable magnification of a light spot formed on a treatment plane, e.g., a patient's retina, by moving one or more lenses in a manner that causes the movement of the illuminator's focal plane. Thus, in traditional variable spot size illuminators, although the illuminator may be parfocal with an observation system at one spot size, the parfocality is lost at a different spot size. This in turn requires the surgeon to refocus or re-accommodate at different spot sizes, and further adversely affects the image quality, e.g., sharpness of focus, of the treatment spot.

Accordingly, there is a need for variable spot size illuminators that can allow readily adjusting the size of a light spot illuminating a selected portion of a patient's retina.

There is also a need for such illuminators that provide light spots having substantially uniform intensities over the illuminated portion of the retina.

Further, there is a need for illuminators that allow adjusting the size of an illumination spot while ensuring that the illumination fluence remains substantially constant.

There is also a need for such illuminators that allow adjusting the size of an illumination spot while ensuring that the illuminator's focal distance, known also as the working distance, remains substantially constant, thereby maintaining parfocality with other optical systems coupled to the illuminator.

### SUMMARY OF THE INVENTION

The present invention provides variable spot size illuminators that can provide a desired light intensity profile on a treatment plane whose size can be readily adjusted while its fluence remains substantially constant. More specifically, the illuminators of the invention can provide continuous or discrete variability of the size of an illumination spot on a treatment plane. Further, these illuminators can provide illumination spots having substantially uniform intensity over the illuminated area with a substantially constant fluence and substantially constant working focal distance as the size of the illuminated area is varied.

A variable spot size illuminator of the invention can include a first optical system that generates a homogeneous distribution of a selected radiation on an intermediate plane, and a variable aperture disposed in the intermediate plane for selecting a portion of the homogeneous distribution. A homogeneous distribution of radiation as used herein refers to a radiation intensity profile that varies by less than about 10 percent around an average value over a selected illuminated area, and falls sharply to vanishing values at the boundaries of this area. The illuminator can further include an objective optical system disposed in substantially fixed position relative to the intermediate plane and optically coupled thereto so as to form an image of the portion of the radiation distribution selected by the aperture on an illumination plane.

In a related aspect, the first optical system in a variable spot size illuminator of the invention as described above can include a radiation source, e.g., a laser operating at a selected wavelength, and a focusing lens system that receives radiation from the radiation source. The terms “radiation” and “light” are herein utilized interchangeably. In particular, the term “light” can refer to radiation having wavelength components that lie in the visible range of the electromagnetic spectrum, or outside the visible range, e.g., the infrared or ultraviolet range of the electromagnetic spectrum. The focusing lens system, which can be formed by a convergent lens, generates an image of the radiation source on the intermediate image plane, and the variable diameter aperture, which can be, for example, in the form of a circular iris, selects a portion of the intermediate image. Further, the illuminator's objective optical system can include an objective lens system that re-images the selected portion of the intermediate image onto the illumination or treatment plane to generate an image having a desired size. The generation or formation of an image on a plane as used herein is intended to encompass generating an image on the plane or generating an image in close proximity of the plane, for example, within a few millimeters (e.g., 2 or 3 mm) of the plane. Varying the size of the aperture results in selecting different sized portions of the intermediate image and hence changing the size of the treatment image. Further, the objective lens system is positioned at a substantially fixed distance relative to each of the intermediate and the treatment planes to ensure that the image formed on the treatment plane exhibits a substantially constant fluence and a substantially constant working focal distance at different sizes.

In another aspect, the variable spot size illuminator includes a homogenizer disposed between the radiation source and the intermediate image plane to spatially homogenize light emitted by the source, thereby generating a substantially homogeneous intensity profile at the target treatment site. For example, the image at the treatment plane can exhibit a substantially homogeneous intensity profile, e.g., an intensity profile that varies by less than about 10 percent around an average value, over the image and falls sharply to vanishing values at the image boundaries. Such an intensity profile is herein referred to as a flat-top intensity distribution. Such a homogeneous image formed on the treatment plane is particularly advantageous when the illuminator is employed for performing various ophthalmic surgical procedures, as described in more detail below.

In a related aspect, the homogenizer can be a light shaping diffuser, a micro-lens array, or any other homogenizer that can be incorporated in an illuminator of the invention to provide a desired spatial homogeneity of the radiation intensity profile.

In another aspect, a collimator, for example, a convergent lens, is disposed between the light source and the focusing lens system to transform the light received from the light source into a collimated beam for illuminating the focusing lens system. The homogenizer can be positioned between the collimator and the focusing lens to ensure that the light imaged by the focusing lens system on the intermediate plane is spatially homogenized.

Although a variety of radiation sources can be employed in variable spot size illuminators of the invention, in many embodiments, the radiation source is a laser operating at a wavelength suitable for a particular application. For example, a laser generating visible green light at a wavelength of 532 nm can be employed for performing photo-coagulation. Moreover, lasers generating radiation having wavelengths in a range of about 600 nm to about 900 nm can be used to perform photodynamic therapy.

In a related aspect, an optical fiber coupled to the laser can deliver the light from the laser to the other components of the illuminator. A fiber mode scrambler can be coupled to the fiber to mix energy among various fiber modes excited by the light source, thereby enhancing the intensity homogeneity of the fiber light output.

In another aspect, the objective lens system can be positioned between the intermediate plane and the treatment plane so as to provide a magnification in a range of about 1× to about 6× of the treatment image relative to the portion of the intermediate image selected by the variable aperture. In embodiments in which the treatment image exhibits a disk-like illumination intensity profile, the magnification can be chosen so as to provide an illumination disk having a diameter in a range of about 1 mm to about 6 mm on the treatment plane.

In another aspect, in a variable spot size illuminator of the invention, the first optical system includes an integrating sphere that is optically coupled at an input port thereof to a radiation source to receive radiation from the source. The integrating sphere spatially homogenizes the received radiation through a multiplicity of reflections, and delivers the spatially homogenous radiation to the intermediate plane via an output port that is disposed in proximity of the intermediate plane. The variable aperture disposed in the intermediate plane can select a portion of this homogeneous radiation distribution, and the objective optical system, which can be an objective lens disposed between the intermediate plane and the illumination plane, can form an image of the selected portion on the illumination plane.

In other aspects, a variable spot size illuminator of the invention can include a light guidance device, such as an optical pipe or optical rod, that is coupled at an input port to a radiation source. The optical pipe spatially homogenizes the radiation received from the source, and delivers the spatially homogeneous radiation to the intermediate plane via an output port disposed in proximity of the intermediate plane. The variable aperture selects a portion of the radiation on the intermediate plane, and the objective optical system, which can be the form of a convergent lens, forms an image of the selected portion on the illumination plane.

In another aspect, the invention provides a variable spot size illuminator that allows varying the size of an image formed on the treatment plane among a plurality of pre-defined discrete values. Such a discrete variable spot size illuminator can include a radiation source, e.g., a laser, and a plurality of light shaping diffusers, each of which includes a pre-defined optical relief, produced for example by holographic techniques, that imparts a desired far field intensity profile to radiation transmitted therethrough. The illuminator can further include a positioning device coupled to the diffusers for selectively coupling any desired one of the diffusers to the light source for receiving light. An objective lens disposed between the selected diffuser and a treatment plane images the light transmitted through the diffuser onto the treatment plane to generate an image having the far field intensity profile associated with the selected diffuser.

In a related aspect, each diffuser can impart to the light transmitted therethrough a far field intensity profile that is different from the profile corresponding to the other diffusers. For example, the diffusers can be designed such that each would effect the generation of a disk-like intensity profile on the treatment plane having a diameter different from that obtained by utilizing a different diffuser. In this manner, the spot size of the treatment image can be varied among a discrete set of values by simply positioning a different diffuser in the optical path.

In another aspect, a collimator, for example, a convergent lens, is disposed between the light source and selected diffuser to generate a collimated beam for illuminating the diffuser. Although many different coherent and non-coherent radiation sources can be employed in a discrete variable spot size illuminator of the invention, in many preferred embodiments, the radiation source is a laser operating at a selected wavelength. An optical fiber can be coupled to the laser to deliver light to the other components of the illuminator, e.g., the collimator. Further, a fiber mode scrambler can be coupled to the optical fiber to mix energy among various fiber modes to generate a fiber light output having enhanced spatial homogeneity.

Further understanding of the invention can be obtained by reference to the following detailed description in conjunction with the associated drawings described briefly below.

### BRIEF DESCRIPTION OF THE DRAWINGS

FIG. 1A schematically illustrates a continuous variable spot size illuminator according to the teachings of the invention,

FIG. 1B schematically illustrates the illuminator of FIG. 1A in which a mode scrambler is incorporated to spatially homogenize the output radiation of an optical fiber optically coupled to a radiation source,

FIG. 1C schematically illustrates the illuminator of FIG. 1A in which a light shaping diffuser is incorporated to spatially homogenize the radiation received by an intermediate plane,

FIG. 2 schematically illustrates another continuous variable spot size illuminator of the invention that utilizes a microlens array for spatially homogenizing output radiation of an optical fiber coupled to a radiation source,

FIG. 3 schematically illustrates another continuous variable spot size illuminator of the invention that utilizes an integrating sphere for generating a homogeneous radiation distribution on an intermediate plane,

FIG. 4 schematically illustrates yet another continuous variable spot size illuminator of the invention employing a light pipe/rod for radiation intensity homogenization,

FIG. 5 schematically illustrates another variable spot size illuminator according to the teachings of the invention in which an ophthalmic observation system is incorporated to be utilized in a parfocal manner with the illuminator, and

FIG. 6 schematically illustrates a discrete variable spot size illuminator of the invention that employs a plurality of light shaping diffusers including different optical holograms for selecting the size of an image formed on an illumination plane from among a discrete number of choices.

### DETAILED DESCRIPTION OF THE INVENTION

The present invention provides both continuous variable spot size illuminators and discrete variable spot size illuminators that can be utilized in many applications, e.g., ophthalmic surgical procedures, to provide a light spot on a treatment plane, e.g., a patient's retina, whose size can be continuously or discretely adjusted while ensuring that the illumination fluence and focal distance remain substantially constant at all spot sizes. A continuous spot size illuminator of the invention can employ a variable aperture disposed on an intermediate image plane to select a portion of an intermediate image of a light source, and an objective lens system to image the selected portion of the intermediate image on the treatment plane. A discrete variable spot size illuminator of the invention can utilize a plurality of light shaping diffusers having different optical relief structures to generate different spot sizes on the treatment plane, as discussed in more detail below.

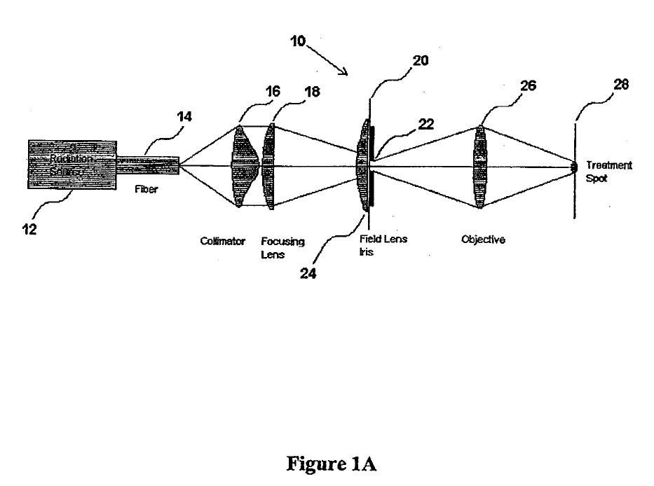

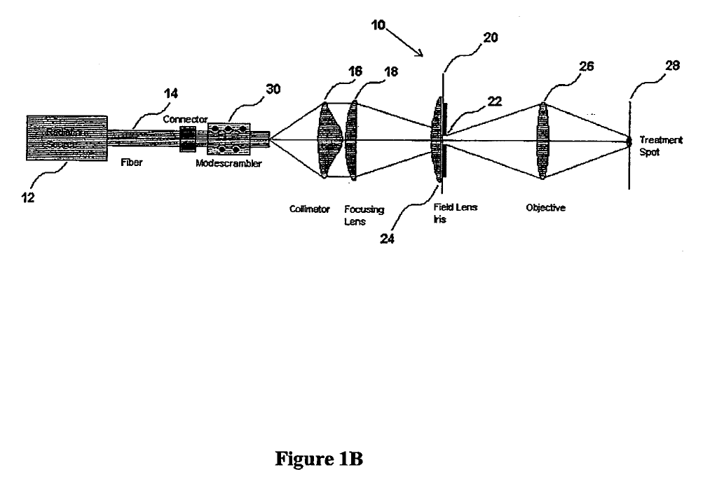

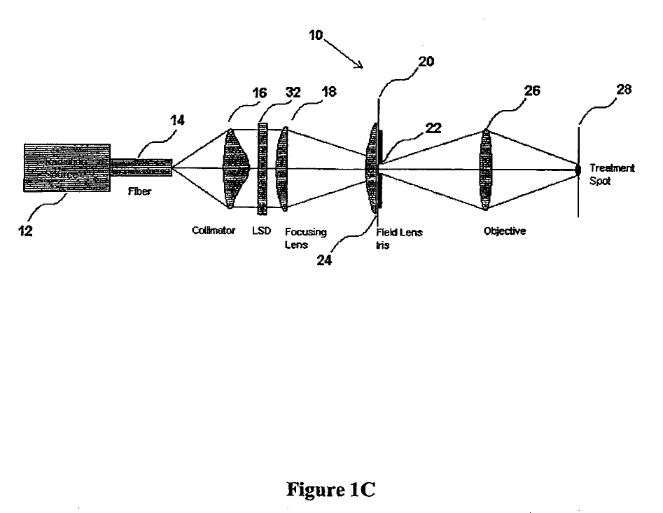

FIG. 1A schematically illustrates a variable spot size illuminator 10 according to the teachings of the invention that includes a radiation source 12, e.g., a laser, coupled to an optical fiber 14 that delivers the radiation emitted by the radiation source to a collimator lens 16. The collimator lens 16, which can be a convergent lens, generates a collimated beam in response to the illumination from the optical fiber 14.

An aiming beam (not shown) can be coupled into the same optical fiber 14 for the convenience and safety of an operator of the illuminator. The aiming beam can then be delivered onto an illumination/treatment plane through the same optical path as that traversed by a treatment radiation generated by the radiation source 12. This can be achieved, for example, by utilizing a beam splitter in the form of a wavelength-dependent dielectric 45° mirror because the wavelength of the aiming beam is generally different than that of the treatment beam. Further, achromatic optical elements can be employed to minimize differences in the delivery of treatment and aiming beams. Those having ordinary skill in the art will appreciate that the radiation source 12 can include sources for generating both a treatment beam and an aiming beam, coupled to the optical fiber 14, for use in the illuminator 10, as discussed in more detail below.

A focusing lens 18, for example, a convergent lens, is positioned at a selected distance relative to the collimator to generate an image of the incident beam on an intermediate image plane 20. In this exemplary embodiment, the image formed on the intermediate plane may have a disk-like intensity profile with a diameter that can be in a range about 1 to about 10 millimeters. By way of example only, the diameter of the disk-like image formed on the intermediate plane can be approximately 3 millimeters. The focal length of the collimator lens 16 and that of the focusing lens, together with their positions relative to one another and relative to the output end of the fiber and the intermediate image plane, can be selected so as to obtain different magnification values for the intermediate image relative to the fiber output. Exemplary magnification values corresponding to the intermediate image suitable for use in the practice of invention can be in a range of about 5 to about 50. Those having ordinary skill in the art will appreciate that other magnification values can also be selected. In general, a magnification value can be selected based on a desired application of the variable spot size illuminator 10.

A variable aperture 22, which may be a circular iris, whose diameter can be continuously varied over a selected range, for example, from zero to about 3 mm, is disposed in the intermediate image plane 20. The aperture 22 can be employed to select a portion of the image formed on the intermediate plane 20. For example, in this exemplary embodiment, continuously varying the iris diameter results in changing the diameter of the disk-like intensity profile of the image formed on the intermediate plane.

A field lens 24, disposed immediately adjacent to the aperture 22, is optionally employed to increase efficiency of light collection on the intermediate plane. The field lens can be a convergent lens having a focal length and a diameter that are suitable for a particular application. Although in this exemplary embodiment, the field lens is disposed on the input side of the aperture 22, those having ordinary skill in the art will appreciate that the field lens can also be disposed on the output side of the aperture 22.

The exemplary illuminator 10 also includes an objective lens 26 disposed at a substantially fixed distance relative to each of the intermediate plane 20 and a treatment plane 28. The objective lens 26 generates an image of the portion of the intermediate image selected by the aperture 22, i.e., the light intensity profile confined by the aperture 22, on the treatment plane 28. The substantially fixed position of the objective lens 26 relative to both the intermediate plane and the treatment plane helps ensure that the image formed on the treatment plane would exhibit a relatively constant fluence and a relatively constant focal distance independent of the size of the portion of the intermediate image selected by varying the aperture diameter.

Hence, the exemplary illuminator 10 allows providing a disk-like light spot on the treatment plane whose size can be continuously varied by changing the aperture diameter. Although a circular iris is tilized for aperture 22 in the above embodiment, those having ordinary skill in the art will: appreciate that variable apertures shaped differently can also be utilized in an illuminator of the invention to generate any desired light intensity profile on the treatment plane.

Thus, the above exemplary illuminator 10 can be viewed as a combination of two optical systems, one of which forms an image of a source, e.g., light output of an optical fiber, onto an intermediate plane at a first magnification value, and the other system, herein referred to as the objective system, re-images the intermediate image onto a treatment plane at a second magnification, which may be the same or different than the first magnification. The magnification provided by the objective system, i.e., the magnification exhibited by the image formed on the treatment plane relative to the image on the intermediate plane, can be selected based on a number of considerations. For example, the magnification can be selected so as a working distance associated with the illuminator, that is, the distance between the last optical element, e.g., objective lens, and the treatment plane, would allow convenient use of the illuminator. Further, the objective lens is preferably positioned sufficiently close to the intermediate plane to allow efficient light collection from the intermediate image. Moreover, the magnification of the objective system can be preferably selected to achieve the maximum diameter of the light spot formed on the treatment plane required by a particular application. In this exemplary embodiment, the magnification of the objective system can be in a range of about 1 to about 10. Those having ordinary skill in the art will, however, appreciate that other magnification values can also be selected.

FIG. 1B schematically illustrates that a fiber mode scrambler 30 can be incorporated into the variable spot size illuminator 10 so as to be optically coupled to the optical fiber 14. The fiber mode scrambler 30 mixes energy of various fiber modes excited by the light source in order to enhance the spatial homogeneity of the output light of the fiber. A variety of fiber mode scramblers are known in the art and can be employed in the practice of the present invention. For example, U.S. Pat. No. 4,934,787, herein incorporated by reference, describes a mode scrambler that can convert the mode distribution of light transmitted through an optical fiber into a stationary mode distribution. Details regarding other exemplary mode scrambling arrangements can be found in U.S. Pat. No. 4,974,930 and U.S. Pat. No. 4,676,594, both of which are herein incorporated by reference.

In other embodiments of the invention, light shaping diffusers (LSD), integrating spheres, lens arrays, or light pipes coupled to the optical fiber 14 can be employed, instead of or in combination with mode scramblers, for spatially homogenizing the output light of the optical fiber 14. For example, FIG. 1C schematically depicts that a light shaping diffuser 32 can be incorporated into the exemplary illuminator 10 to receive the collimated beam formed by the collimator lens 16, and to generate an output beam with enhanced intensity homogeneity in a plane perpendicular to the propagation direction. In this exemplary embodiment, the output of the optical fiber has a disk-like cross-sectional intensity profile. Hence, the diffuser 32 helps ensure that the disk-like cross-sectional light intensity is relatively uniform over the disk and falls off rapidly beyond the disk's perimeter. Such an intensity profile is herein referred to as a flat-top intensity distribution. In some preferred embodiments of the invention, the variation of intensity across the flat-top intensity profile is within about 10% of an average value. Such intensity homogeneity is particularly advantageous when the illuminator is utilized to perform photo-dynamic therapy (PDT), as described in more detail below. One having ordinary skill in the art will recognize that variations in the intensity greater than 10% may be acceptable in some applications.

A variable spot size illuminator of the invention, such as that described above, can find a variety of applications. For example, such an illuminator can be utilized in photodynamic therapy (PDT) in which a drug, commonly referred to as photosensitizer that is harmless in the absence of activation, is administered to a patient, and is subsequently activated by light having a selected wavelength to selectively destroy abnormal tissue containing it.

For example, PDT can be employed for treatment of age-related macular degeneration (AMD) that is a common eye condition that can cause significant visual loss. One form of AMD is caused by growth of abnormal blood vessels under the patient's retina that leak blood and fluid. Photodynamic therapy can be employed to close the leaking blood vessels without damaging the overlying retina. More particularly, an illuminator of the invention can provide a laser light spot with a selected size on the desired portion of the patient's retina to activate a photosensitizer previously administered to the patient, thereby closing the leakage. The laser can provide light with a wavelength in a range of about 664 nm to about 810 nm, and preferably in a range of about 664 nm to about 732 nm, and more preferably in a range of about 689 nm to about 690 nm, to activate the photosensitizer, which: can be, for example, Verteporfin available under trade designation Visudyne from Novartis Pharmaceuticals of Canada.

One advantage of the use of an illuminator of the invention in performing photodynamic therapy is that it provides a relatively uniform light intensity over the illuminated area of the retina, which remains stable over the treatment period, e.g., a few minutes. Further, the size of the spot can be readily modified while ensuring that the light fluence and focal distance remain substantially constant.

In another application, a variable spot size illuminator of the invention, such as the variable illuminator described above, can be utilized with a laser operating at a selected wavelength, for example, a laser generating green light at 532 nm, to perform photo-coagulation therapy on a patient's retina. More specifically, the illuminator can direct a laser light spot onto a portion of the patient's retina to cause coagulation of the illuminated tissue by energy deposition. Photocoagulation can be employed, for example, to seal leaky blood vessels or repair retinal detachment. For example, photocoagulation can be employed for treating a number of disease conditions of the eye known as macular degeneration (MD). For example, in the treatment of the wet form of macular degeneration, the heat generated by a laser light spot directed to the patient's retina can cauterize abnormal blood vessels growing beneath the patient's retina to seal them and prevent leakage.

In addition, a variable spot size illuminator of the invention can be employed for performing transpupillary thermal therapy (TTT). For example, an illuminator of the invention having a diode laser operating at 810 nm as a radiation source can be employed to heat up large areas of retina to an elevated temperature, e.g., about 49° C.

A variety of focal lengths and diameters can be selected for the lenses, such as the collimator 16, the focusing lens 18, and the objective lens 26. In addition, different sizes for the aperture 22 in the intermediate plane can be utilized. Moreover, the magnification of the intermediate image and that of the image formed on the treatment plane can be selected to suit a particular application of the variable spot size illuminator. By way of example, Table 1 below lists some exemplary values of the magnification associated with the intermediate image relative to an input light spot such as the output of the optical fiber 14, (M1), the focal length (F1) and diameter (D1) of the collimator, the focal length (F2) and diameter (D2) of the focusing lens, the focal length (F3) and diameter (D3) of the objective lens, the magnification of the objective system (M2), and diameters of the intermediate image spot and the spot on the treatment plane for a variety of therapies that can be performed by utilizing an illuminator of the invention. All distances in Table 1 are provided in millimeters.

TABLE 1

| Therapy | Design | M1 | F1 | D1 | F2 | D2 | Dᵢₙₜ | F3 | D3 | M2 | D_{Treat} |
|---|---|---|---|---|---|---|---|---|---|---|---|
| PDT | Mode Scrambler | 10 | 5 | 5 | 50 | 5 | 3 | 50 | 50 | 2.7 | 8 |
| PDT | Microlens Array | 10 | 5* | 5* | 50 | 5 | 3 | 50 | 50 | 2.7 | 8 |
| PDT | LSD Continuous | 10 | 5 | 5 | 50 | 5 | 3 | 50 | 50 | 2.7 | 8 |
| PDT | Integr. Sphere | | | NA | | | 3 | 50 | 50 | 2.7 | 8 |
| PDT | Light Pipe/Rod | | | NA | | | 3 | 50 | 50 | 2.7 | 8 |
| PDT | LSD Discrete | 10 | 5 | 5 | 50 | 5 | 3 | 50 | 50 | 2.7 | 8 |
| TTT | Same Designs as | Same as PDT | | | | | | | | | |
| | PDT | | | | | | | | | | |
| Coagulation | Fiber | 10 | 5 | 5 | 50 | 5 | 1 | 100 | 50 | 1 | 1 |

*Microlens Array is composed for example of 25 lenslets with F = 1.25 mm and D = 1 mm.

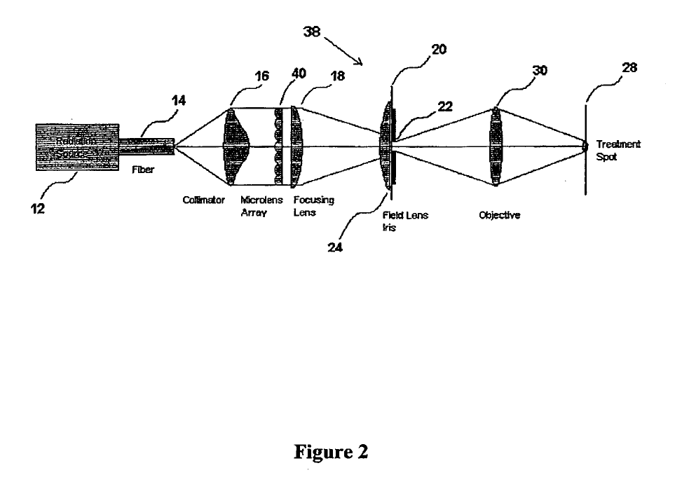

A variety of systems can be utilized in an illuminator of the invention to enhance spatial homogeneity of the image formed on the intermediate plane, and consequently that of the image formed on the treatment plane. For example, a light shaping diffuser and/or a mode scrambler can be employed for this purpose. FIG. 2 schematically illustrates another illuminator 38 in accordance with the teachings of invention in which a microlens array 40, disposed between the collimator lens 16 and the focusing lens 18, is employed for enhancing the spatial homogeneity of an intermediate image that is generated by the focusing lens. The illuminator 38 functions similarly to the illuminator 10 in that the focusing lens 18 generates a homogeneous illuminated area by combining multiple individual beams produced by the lenslets of the micro-lens array 40 on the intermediate plane 20, and the objective lens 30 further re-images the intermediate image selected with the aperture 22 on the treatment plane 28. The use of a microlens array as a light homogenizer in the illuminator 38 provides a number of advantages, such as, relatively high light transmission (e.g., a transmission coefficient greater than 80%) and good homogenization.

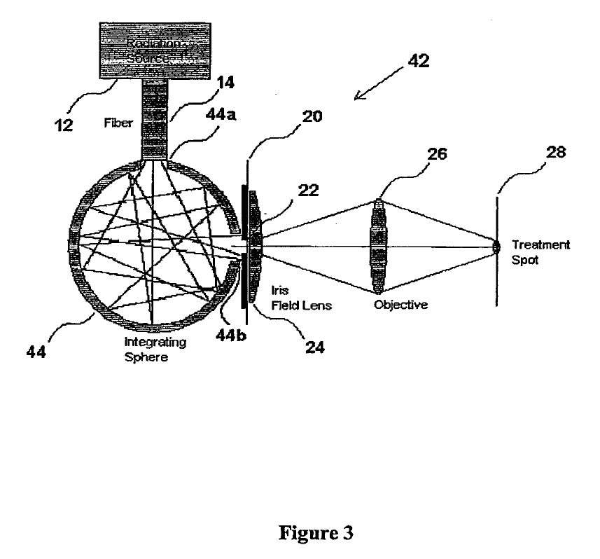

FIG. 3 schematically illustrates another illuminator 42 of the invention in which the output of the optical fiber 14 is coupled to an integrating sphere 44 at an input port 44a thereof. The light entering the sphere can undergo many internal reflections before exiting the sphere at its output port 44b. The multiple reflections advantageously increase the spatial homogeneity of the light emerging from the output port 44b relative to the light entering the sphere at the input port 44a. In this illuminator, the intermediate image plane 20 is disposed at the exit port of the sphere. And the variable diameter aperture 22 disposed in the intermediate plane allows selecting a portion of the light emerging from the integrating sphere for imaging onto the treatment plane 28. For example, the aperture 22 allows selecting a disk-like intensity profile having a desired diameter.

Similar to the previous embodiments, the objective lens 26 is disposed at a substantially fixed distance relative to each of the intermediate plane 20 and the treatment plane 28 to image the light selected by the aperture onto the treatment plane. Further, the field lens 24 is optionally disposed immediately adjacent to the aperture to enhance collection of light emerging from the aperture by the objective lens 26. In particular, the propagation directions of the light rays emerging from the aperture 22 span a 180-degree solid angle with the light intensity decreasing as the propagation direction moves away from the central propagation direction, i.e., a direction perpendicular to the plane of the aperture 22. In the absence of the field lens, those light rays emerging from the aperture that propagate outside a solid angle subtended at the aperture 22 by the objective lens miss the objective lens, and hence are not imaged on the treatment plane. The field lens advantageously diverts some of these light rays into directions that are within the collection angle of the objective lens, thereby enhancing the image formed on the treatment plane. That is, the field lens, which can be a convergent lens, enhances light collection efficiency.

The use of an integrating sphere as a light homogenizer is advantageous in that the sphere provides a non-coherent light output free of any speckle patterns. In the above illuminator 42, the diameter of the aperture 22 can be selected to be, e.g., 3 mm, and the focal length and the diameter of the objective lens 26 can be both selected to be about 50 mm. In addition, the objective lens 26 can be disposed relative to the aperture and the treatment plane such that the objective system exhibits a magnification of about 2.7, thereby generating an 8 mm light spot on the treatment plane as an image of a 3 mm aperture. Similar parameter values can be utilized when the illuminator 42 is employed for performing transpupillary thermal therapy. Those having ordinary skill in the art will appreciate parameter values other than those described above can also be employed.

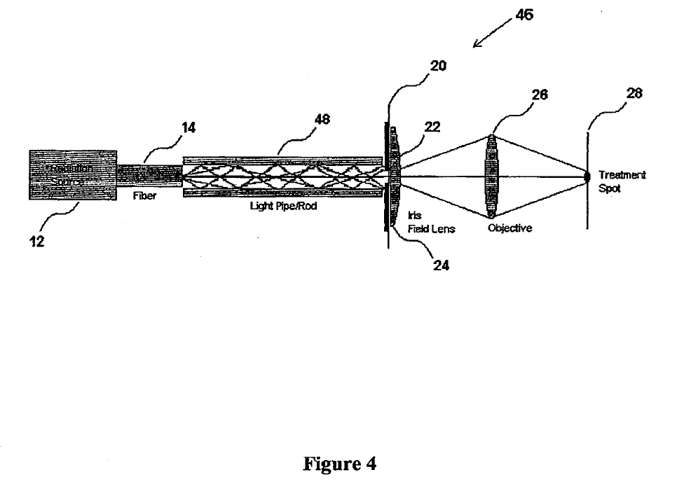

With reference to FIG. 4, another variable spot size illuminator 46 according to the teachings of the invention employs a light pipe or a light rod 48 for spatially homogenizing the output light emerging from the optical fiber to help ensure that a flat-top light intensity distribution is provided in the treatment plane. Similar to the previous embodiments, the variable aperture 22 allows selecting a portion of the light emerging from the light pipe, and the field lens 24 enhances the collection of light by the objective lens 26, which images the aperture onto the treatment plane 28. The light pipe advantageously exhibits a high light transmission coefficient, e.g., about 70%. Further, the light pipe provides a non-coherent light output because it transports light through scattering, which results in a treatment image that is free of any speckle pattern. It should be noted that in embodiments in which a light rod, rather than a light pipe, is utilized, coherence is conserved because a light rod transports light through a full internal reflection.

When the above illuminator 46 is employed for performing photodynamic therapy, the aperture 22 can have a diameter, e.g., of 3 mm, and the objective lens 26 can have a focal length of about 50 mm and a diameter of about 50 mm. Further, the position of the objective lens relative to the aperture and the treatment plane can be selected such that the magnification of the objective system, i.e., the magnification of the spot formed on the treatment plane relative to aperture size, is about 2.7. That is, the spot on the treatment plane 28 will be about 8 mm in diameter for an aperture size of 3 mm. Similar exemplary parameter values can be utilized when the illuminator 46 is employed for performing transpupillary thermal therapy. When the illuminator 46 is utilized for performing photocoagulation, the diameter of the aperture 22 can be selected to be, e.g., about 1 mm, and the objective lens can be selected to have a focal length, e.g., of about 100 mm and a diameter of about 50 mm. In addition, the objective lens can be positioned relative to the aperture and the treatment plane such that the magnification provided by the objective system is unity. For example, a 1 mm aperture is imaged onto a 1 mm spot on the treatment plane.

One significant advantage of the use of a variable diameter aperture in an illuminator of the invention is that the fluence of the image spot formed on the treatment plane is substantially constant at all spot sizes. This is particularly advantageous when the illuminator is employed for performing photodynamic therapy or transpupillary thermal therapy as the fluence of the treatment spot is a parameter of the treatment protocol in these procedures. The fluence of the treatment spot in these procedures should preferably remain within approximately percent of a desired value in order to obtain optimal results. Larger deviations of the treatment spot's fluence can adversely affect the outcome, and in some cases, it can be dangerous. Although a larger variation of the treatment spot's fluence can be tolerated in photocoagulation therapy, a substantially constant fluence is still desirable for obtaining repeatable outcome.

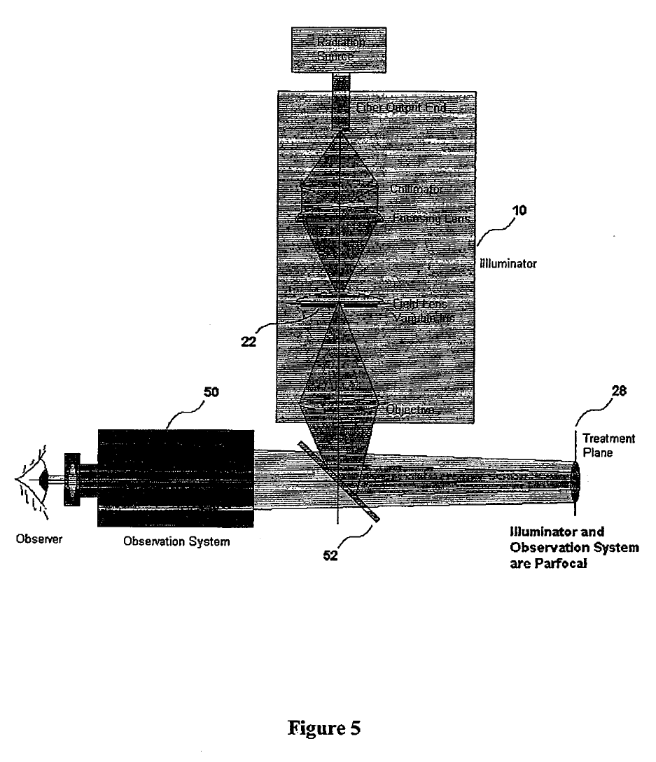

Another advantage of an illuminator of the invention is that it can be employed in a parfocal manner relative to an observation system, e.g., a slit lamp microscope, at a plurality of spot sizes formed on the treatment plane without a need to adjust the focus of the microscope upon a change in the spot size. By way of example, FIG. 5 schematically illustrates an illuminator of the invention in which an ophthalmic observation system 50, e.g., a slit lamp microscope or an indirect ophthalmoscope, is incorporated. A partially reflective mirror 52 directs radiation from the radiation source and optical components of the illuminator to the treatment plane 28, and allows viewing of the treatment plane, for example, a patient's retina, by a surgeon employing the observation system 50. A transmission spectrum of the mirror 52 can be chosen such that it allows the passage of a low-intensity aiming beam that is safe for an observer while blocking a high power beam employed for treatment. Once the treatment plane is brought into focus relative to the observation system 50 and the objective optical system of the illuminator, the illuminator and the observation system become parfocal. This parfocality condition is preserved as the size of the light spot formed on the treatment plane varies by adjusting the size of the variable aperture 22 because the objective lens remains fixedly positioned relative to the intermediate plane and the treatment plane.

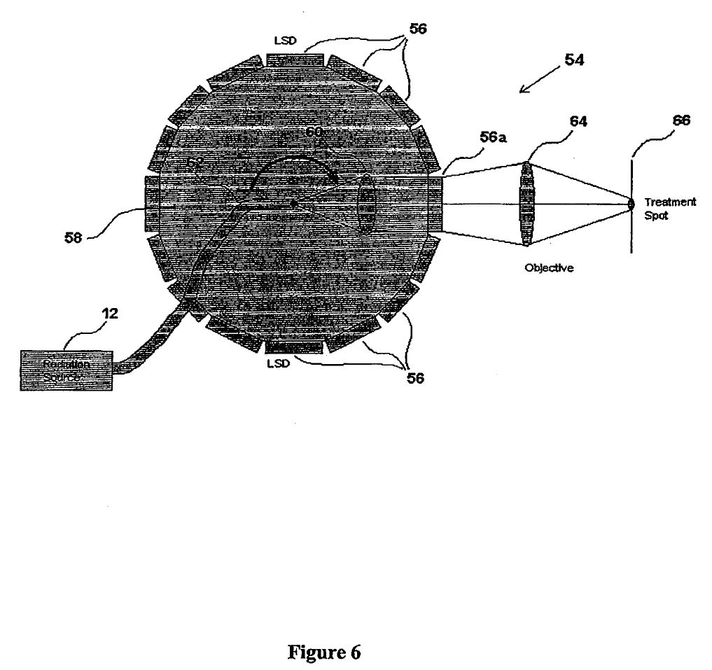

In the embodiments described above, the size of the treatment image can be continuously varied over a selected range by changing the aperture diameter. The present invention also teaches variable spot size illuminators in which the size of a treatment spot can be discretely varied among a set of pre-selected values. By way of example, FIG. 6 schematically illustrates a variable spot size illuminator 54 of the invention that utilizes a plurality of holographic light shaping diffusers (LSD) 56 to provide a discrete number of different sized treatment spots.

More particularly, the LSD's are disposed around the circumference of a wheel 58 that can rotate to bring a selected one of the LSD's into register with a collimator lens 60. An optical fiber 62 delivers light from a light source 12, such as, a laser, to the collimator 60 that generates a collimated beam to illuminate one of the LSD's, e.g., LSD 56a, that is positioned to receive the collimated beam. An objective lens 64 directs the light output of the LSD onto the treatment plane 66.

Each LSD 56 generates a flat-top far field light output whose shape and size are determined by the holographic scattering pattern, herein referred to as the holographic pattern, recorded thereon. In some preferred embodiments, the holographic pattern recorded on each LSD provides a far field disk-like intensity profile having a selected diameter that differs from a diameter provided by another LSD. In other words, the size of the disk-like image provided on the treatment plane by the objective lens depends on the LSD selected to receive light from the collimator 60. In this manner, a discrete number of different image sizes can be obtained by simply replacing one LSD that is in register with the collimator lens with another having a different relief pattern.

Light shaping diffusers suitable for use in the above exemplary discrete variable spot size illuminator of the invention are known in the art. For example, U.S. Pat. No. 6,158,245, herein incorporated by reference in its entirety, describes a surface light shaping diffuser that is formed from a monolithic glass material by recording light shaping structures in the glass material during its formation. Such an LSD exhibits a transmission efficiency of over 90% from the ultraviolet wavelengths to the visible spectrum.

Suitable light shaping diffusers are commercially available. For example, such light shaping diffusers can be obtained from MEMS optical, Inc. of Huntsville, Ala., U.S.A, or Heptagon Corporation of Espoo, Finland.

Those having ordinary skill in the art will appreciate that various changes can be made to above exemplary embodiments without departing from the scope of the invention. For example, light homogenizers other than those described above can be utilized in the practice of the invention.

What is claimed is:

1. A variable spot size illuminator, comprising
a) a first optical system for generating a homogeneous distribution of a selected radiation on an intermediate plane,
b) a variable aperture disposed in said intermediate plane for selecting a portion of said homogenous distribution of radiation, and
c) an objective optical system substantially fixedly positioned relative to said intermediate plane and optically coupled thereto so as to generate an image of said selected portion onto an illumination plane.

2. The variable spot size illuminator of claim 1, wherein said objective optical system generates the image of said selected portion at a substantially constant focal distance independent of a size of the image.

3. The variable spot size illuminator of claim 1, wherein an intensity of radiation over said homogeneous distribution varies by less than about 10% around an average intensity value.

4. The variable spot size illuminator of claim 1, wherein said first optical system comprises
a) a source of radiation, and
b) a focusing lens system for generating said homogeneous distribution of radiation on the intermediate plane as an image of said radiation source.

5. The variable spot size illuminator of claim 4, wherein said objective optical system comprises an objective lens system positioned between said intermediate plane and said illumination plane, wherein said objective lens system is positioned at a substantially fixed distance relative to each of said intermediate and said illumination planes.

6. The variable spot size illuminator of claim 1, wherein said first optical system comprises
a) a source of radiation, and
b) an integrating sphere optically coupled to said source of radiation at an input port thereof to receive radiation from said source and to spatially homogenize said received radiation through a plurality of reflections, said integrating sphere having an output port positioned in proximity of said intermediate plane and optically coupled thereto so as form a selected distribution of said homogenized radiation on said intermediate plane.

7. The illuminator of claim 6, wherein said objective optical system comprises at least an objective lens disposed between said intermediate plane and said illumination plane at a substantially fixed distance relative to each of said intermediate and said illumination planes.

8. The variable spot size illuminator of claim 1, wherein said first optical system comprises
a) a source of radiation, and
b) a light guidance device having an input port and an output port, said input port being optically coupled to said radiation source to receive radiation and said output port being disposed in proximity of said intermediate plane to project a spatially homogenized distribution of radiation on said intermediate plane.

9. The variable spot size illuminator of claim 8, wherein said light guidance device is selected from the group consisting of a light pipe and a light rod.

10. The variable spot size illuminator of claim 1, wherein the image formed on the illumination plane exhibits a fluence that remains relatively constant as a size of the image on the illumination plane varies by adjusting said variable aperture.

11. The variable spot size illuminator of claim 1, further comprising a field lens disposed adjacent the variable aperture to enhance illumination of the objective optical system.

12. The variable spot size illuminator of claim 4, wherein said first optical system comprises a homogenizer disposed between said radiation source and said intermediate plane to spatially homogenize light emitted from said source.

13. The variable spot size illuminator of claim 12, wherein said homogenizer comprises a light shaping diffuser.

14. The variable spot size illuminator of claim 12, wherein said homogenizer comprises a micro-lens array.

15. The variable spot size illuminator of claim 12, wherein said homogenizer is positioned between said radiation said focusing lens system.

16. The variable spot size illuminator of claim 4 wherein said focusing lens system comprises a convergent lens.

17. The variable spot size illuminator of claim 4, further comprising a collimator disposed between said radiation source and said homogenizer to collimate radiation emitted from the radiation source.

18. The variable spot size illuminator of claim 1, wherein said first optical system comprises a radiation source.

19. The variable spot size illuminator of claim 18, wherein said radiation source comprises a laser operating at a selected wavelength.

20. The variable spot size illuminator of claim 19, wherein said selected wavelength is suitable for performing photodynamic therapy.

21. The variable spot size illuminator of claim 19, wherein said selected wavelength is suitable for performing transpupillary thermal therapy.

22. The variable spot size illuminator of claim 19, wherein said selected wavelength is suitable for performing photocoagulation therapy.

23. The variable spot size illuminator of claim 20, wherein said radiation source operates at a wavelength in a range of about 600 nm to about 900 nm.

24. The variable spot size illuminator of claim 21, wherein said radiation source operates at a wavelength of about 810 nm.

25. The variable spot size illuminator of claim 22, wherein said radiation source operates at a wavelength of about 532 nm.

26. The variable spot size illuminator of claim 1, wherein said first optical system comprising a radiation source and an optical fiber optically coupled to said radiation source for launching light emitted by the source along a selected direction.

27. The variable spot size illuminator of claim 26, further comprising a fiber mode scrambler coupled to said optical fiber so as to mix energy among modes of the fiber to generate an spatially homogenous fiber light output.

28. The variable spot size illuminator of claim 1, wherein said radiation distribution on said intermediate image has a disk-like intensity profile.

29. The variable spot size illuminator of claim 1, wherein the objective optical system provides a magnification in a range of about 1× to about 6×.

30. The variable spot size illuminator of claim 28, wherein the image formed on the illumination plane has a disk-like intensity profile with a diameter in a range of about 1 mm to about 6 mm.

31. A discretely variable spot size illuminator, comprising
a) a radiation source,
b) a plurality of light shaping diffusers each having a pre-defined optical relief to impart a selected far field intensity profile to light transmitted therethrough,
c) a positioning device coupled to said diffusers to selectively coupling any of said diffusers to said light source for receiving light, and
d) an objective lens disposed between the diffuser selected for coupling to the light source and a treatment plane to image the light transmitted through the diffuser onto the treatment plane, said image having the far field intensity profile corresponding to said selected diffuser.

32. The discretely variable spot size illuminator of claim 31, wherein each of said diffusers imparts to the light transmitted therethrough a far field intensity profile different than the profile corresponding to the other diffusers.

33. The discrete variable spot size illuminator of claim 31, wherein said image formed on the treatment plane has a disk-like intensity profile with a diameter determined by the diffuser selected for coupling to the light source.

34. The discretely variable spot size illuminator of claim 30, wherein each of said optical reliefs is formed holographically.

35. The discretely variable spot size illuminator of claim 30, further comprising an optical fiber coupled to said light source for delivering light to the diffuser coupled to the light source.

36. The discretely variable spot size illuminator of claim 35, further comprising a fiber mode scrambler coupled to said optical fiber for mixing energy among fiber modes thereby spatially homogenizing the fiber output light.

37. The discretely variable spot size illuminator of claim 30, wherein said positioning device comprises a wheel for coupling to said diffusers around a perimeter thereof.
